(19) United States
(12) Patent Application Publication
(10) Pub. No.: US 2007/0174655 A1
(43) Pub. Date: Jul. 26, 2007

(54) System and method of implementing automatic resource outage handling

(76) Inventors: Kyle G. Brown, Apex, NC (US); Mark D. Weitzel, Durham, NC (US); Robert G. Woolf, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/334,863

(22) Filed: Jan. 18, 2006

(51) Int. Cl. G06F 11/00

(52) U.S. Cl. 714/2; 714/5

(57) ABSTRACT

A method, apparatus, and computer-usable medium for determining that at least one resource among a collection of resources implemented in a data processing system has become unavailable, identifying at least one dependent resource among the collection of resources that is dependent on at least one unavailable resource, in response to identifying the at least one dependent resource, disabling the at least one dependent resource, detecting recovery of the at least one unavailable resource, and in response to detecting recovery of the at least one unavailable resource, restarting the at least one dependent resource.

### BACKGROUND OF THE INVENTION

The present invention relates in general to the field of computers and similar technologies, and in particular to software utilized in this field.

When a Java™ 2, Enterprise Edition (J2EE) application running on an Application Server loses connectivity to an external resource, such as a database or messaging system, some or all parts of the application will no longer be able to process requests. The unprocessed requests will eventually fill up buffers and queues in a manner that may lead to a system crash.

Therefore, there is a need for a system, method, and computer-usable medium for addressing the abovementioned limitation of the prior art.

### SUMMARY OF THE INVENTION

The present invention includes a method, apparatus, and computer-usable medium for determining that at least one resource among a collection of resources implemented in a data processing system has become unavailable, identifying at least one dependent resource among the collection of resources that is dependent on at least one unavailable resource, in response to identifying the at least one dependent resource, disabling the at least one dependent resource, detecting recovery of the at least one unavailable resource, and in response to detecting recovery of the at least one unavailable resource, restarting the at least one dependent resource.

The above, as well as additional purposes, features, and advantages of the present invention will become apparent in the following detailed description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1A is a block diagram illustrating an exemplary network in which a preferred embodiment of the present invention may be implemented;

FIG. 1B is a more detailed block diagram depicting an exemplary server cluster in which a preferred embodiment of the present invention may be implemented;

FIG. 2 is a block diagram illustrating an exemplary data processing system in which a preferred embodiment of the present invention may be implemented;

FIG. 3 is a high-level flowchart diagram depicting an exemplary method of implementing automatic resource outage handling according to a preferred embodiment of the present invention.

FIGS. 4A-B show a flow-chart of steps taken to deploy software capable of executing the steps shown and described in FIG. 3;

FIGS. 5A-C show a flow-chart of steps taken to deploy in a Virtual Private Network (VPN) software that is capable of executing the steps shown and described in FIG. 3;

FIGS. 6A-B show a flow-chart showing steps taken to integrate into a computer system software that is capable of executing the steps shown and described in FIG. 3; and

FIGS. 7A-B show a flow-chart showing steps taken to execute the steps shown and described in FIG. 3 using an on-demand service provider.

### DETAILED DESCRIPTION OF AN PREFERRED EMBODIMENT

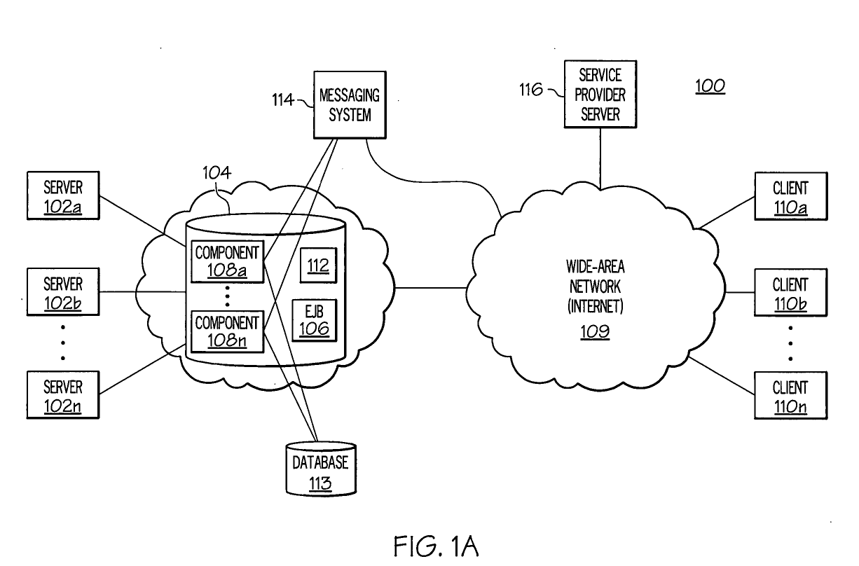

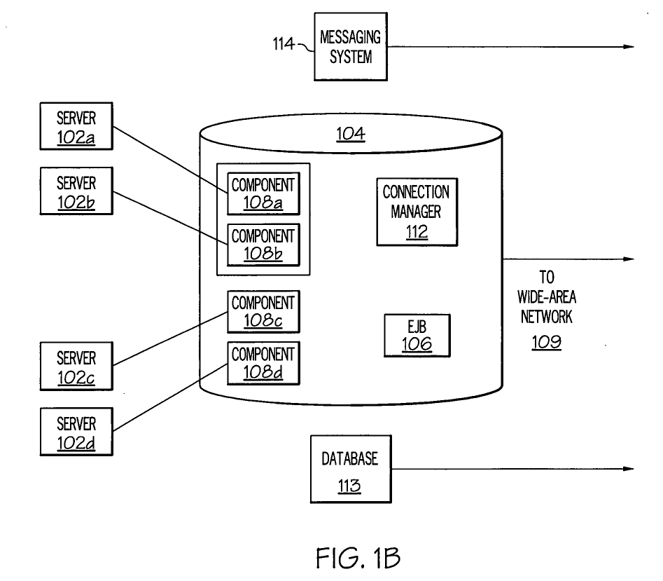

Referring now to the figures, and in particular, referring to FIG. 1A, there is illustrated a block diagram depicting an exemplary network in which a preferred embodiment of the present invention may be implemented. As illustrated, network 100 includes a collection of servers 102a-n, server memory 104, wide-area network (WAN) 109, database 113, messaging system 114, and a collection of clients 110a-n. Clients 102a-n are preferably implemented as computers with access to WAN (e.g., Internet) 109 via a network interface adapter and seek to access a service provided by servers 102a-n.

Servers 102a-n access server memory 104, which may be implemented as a central or distributed memory. Server memory 104 includes a collection of components 108a-n, Enterprise Java Beans 106, and connection manager 112. Enterprise Java Beans 106 defines a component architecture for deployable components (e.g., components 108a-n) and dictates the rules for interaction between components 108a-n.

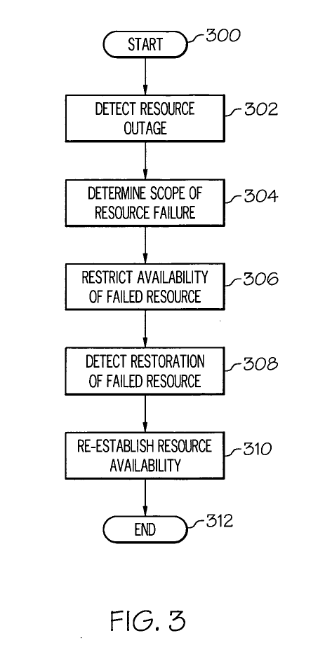

Components 108a-n are preferably implemented as code that implements a set of well-defined interfaces. Each component may be utilized by a system administrator as puzzle pieces to solve a larger problem. For example, an internet bookstore may utilize a first component as an interface for customers to input orders. An inventory component may interface with the first component to determine whether or not the orders can be filled. Connection manager 112, discussed herein in more detail in conjunction with FIG. 3, manages communication and responses to error messages between components 108a-n.

Database 113 and messaging system 114 are external resources coupled to servers 102a-n. Database 113 may be utilized as a mass-storage server to store data generated by the processing performed by servers 102a-n. Messaging system 114, preferably implemented as Java™ Messaging Service (JMS), that enables distributed objects (e.g., servers 102a-n and database 113) to communicate in an asynchronous, reliable manner.

FIG. 1B is a more detailed block diagram depicting the relationships between servers 102a-d and components 108a-d within server memory 104 according to a preferred embodiment of the present invention. As illustrated, server 102a executes the code represented by component 108a, server 102b executes the code represented by component 108b, server 102c executes the code represented by component 108c, and server 102d executes the code represented by component 108d. Also, components 108a-b are preferably implemented as redundant components that share the same responsibilities. For example, server 102a fails or goes offline for any reason, the responsibilities of component 108a are forwarded to component 108b until server 102a is brought back online. Conversely, components 102c-d are preferably implemented as stand-alone components. As previously discussed, messaging system 114 and database 113 are external resources coupled to servers 102a-d.

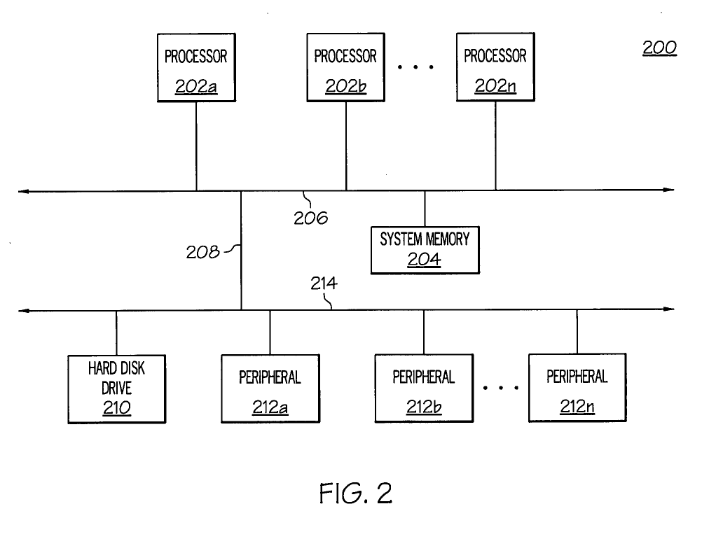

FIG. 2 is a block diagram illustrating an exemplary data processing system 200 in which a preferred embodiment of the present invention may be implemented. Those with skill in the art will appreciate that data processing system 200 may be utilized to implement clients 102a-n. As depicted, exemplary data processing system 200 includes processing unit(s) 202, shown as processing units 202a and 202b in FIG. 2, which are coupled to system memory 204 via system bus 206. Preferably, system memory 204 may be implemented as a collection of dynamic random access memory (DRAM) modules. Typically, system memory 204 includes data and instructions for running a collection of applications. Mezzanine bus 208 acts as an intermediary between system bus 206 and peripheral bus 214. Those with skill in this art will appreciate that peripheral bus 214 may be implemented as a peripheral component interconnect (PCI), accelerated graphics port (AGP), or any other peripheral bus. Coupled to peripheral bus 214 is hard disk drive 210, which is utilized by data processing system 200 as a mass storage device. Also coupled to peripheral bus 214 is a collection of peripherals 212a-n.

Those skilled in the art will appreciate that data processing system 200 can include many additional components not specifically illustrated in FIG. 2. Because such additional components are not necessary for an understanding of the present invention, they are not illustrated in FIG. 2 or discussed further herein. It should also be understood, however, that the enhancements to data processing system 200 for implementing automatic outage handling provided by the present invention are applicable to data processing systems of any system architecture and are in no way limited to the generalized multi-processor architecture or symmetric multi-processing (SMP) architecture illustrated in FIG. 2.

FIG. 3 is a high-level logical flowchart diagram illustrating an exemplary method of implementing automatic resource outage handling according to a preferred embodiment of the present invention.

I. Detecting the Outage:

The process begins at step 300 and proceeds to step 302, which illustrates connection manager 112 detecting a resource (e.g., components 108a-n, database 113, or messaging system 114) outage. Connections between resources are established by connection manager 112, which also inspects error messages issued by resources as a result of their interaction. If connection manager 112 determines that an issued error message indicates a connectivity error, which indicates a resource outage, connection manager 112 notifies servers 102a-n. Servers 102a-n imposes a self-idling process that is dependent on the scope of the resource failure, discussed in more detail in conjunction with steps 304 and 306.

II. Determining the Scope of the Outage:

The process continues to step 304, which depicts connection manager 112 determining the scope of the resource outage. An outage may affect: (1) one or more resources in a set of redundant resources; (2) a stand-alone resource; or (3) an entire set of redundant resources. The three outage cases will be discussed herein in conjunction with FIG. 1B.

A. Case 1: Outage Affects one or More Components in a Set of Redundant Resources:

If connection manager 112 determines that the scope of the outage includes one or more resources in a set of redundant resources (e.g., components 108a-b), connection manager 112 idles the failed components or external resources by preventing new connections to be established to the unavailable resources, finishing existing transactions (preferably by returning error messages indicating the unavailability of the specific resources), and sending existing transactions to be processed by other redundant resources in the set of redundant resources.

For example, as illustrated in FIG. 1B, if connection manager 112 determines that server 102a has gone offline, connection manager 112 prevents the establishment of new connections to component 108a, finishes existing transactions to component 108a by sending error messages to the current connections, and forwarding all new connection requests to component 108b, another redundant component in the set of redundant components 108a-b.

B. Cases 2 and 3: Outage Affects a Stand-Alone Component or an Entire Set of Redundant Components

If connection manager 112 determines that the scope of the outage affects a stand-alone resource (e.g., component 102c or d) or an entire set of redundant resources (e.g., components 102a-b), connection manager 112 idles the unavailable resources by preventing new connections to be established to the unavailable resources, finishing existing transactions (preferably by returning error messages).

III. Restricting Availability of Failed Resources:

Referring again to FIG. 3, the process continues to step 306, which illustrates connection manager 112 restricting the availability of unavailable resources (e.g., components or external resources handed by unavailable servers). The first part of the restricting availability process involves idling the unavailable resources, as previously discussed. The second part of the process involves detecting and idling resources that are affected by the outage.

For example, servers 102a-n may preferably utilize information in application deployment descriptors and Java Naming and Directory Interface (JNDI) to keep track of component or external resource dependencies. In one preferred embodiment of the present invention, each component or external resource must register with connection manager 112 and list all dependent components. In another preferred embodiment of the present invention, connection manager 112 may dynamically detect resource dependencies as each resource accesses connection manager 112 via JNDI lookup. When connection manager 112 detects an outage and determines the scope of the outage, connection manager 112 will impose an idling process on all affected resources.

For instance, if components 108a-b are dependent on component 108c and server 102c becomes unavailable, connection manager 112 detects the outage of component 108c and imposes an idling process (previously discussed in more detail above) on component 108c (the unavailable component) and components 108a-b (because of the dependency of components 108a-b on the unavailable component 108c).

IV. Detecting Recovery

Referring again to FIG. 3, the process continues to steps 308 and 310, which illustrate the detection of the recovery and reestablishment of resource availability. Once the unavailable resources have been idled, connection manager 112 will periodically query the server(s) hosting the unavailable resources to determine when the server(s) return to an online status. Once the offline servers return to an online status, connection manager 112 will return all idled resources to an active state. For example, if server 102a becomes unavailable, component 102a and all dependent components are idled as previously described. Connection manager 112 will query server 102a to determine if the server has returned to an online status. If connection manager 112 determines that server 102a has returned to an online status, connection manager 112 will return component 102a and all dependent components to an active state.

As disclosed, the present invention includes a method, apparatus, and computer-usable medium for determining that at least one resource among a collection of resources implemented in a data processing system has become unavailable, identifying at least one dependent resource among the collection of resources that is dependent on at least one unavailable resource, in response to identifying the at least one dependent resource, disabling the at least one dependent resource, detecting recovery of the at least one unavailable resource, and in response to detecting recovery of the at least one unavailable resource, restarting the at least one dependent resource.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

Thus, the method described herein, and in particular as shown and described in FIG. 3, can be deployed as a process software from service provider server 116 to servers 102a-n.

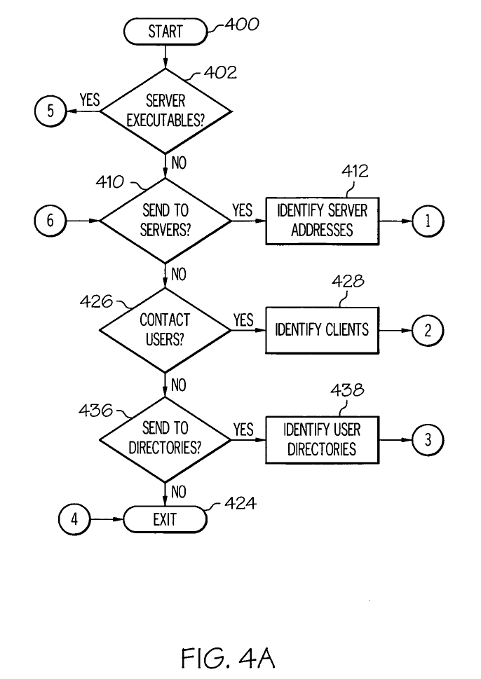

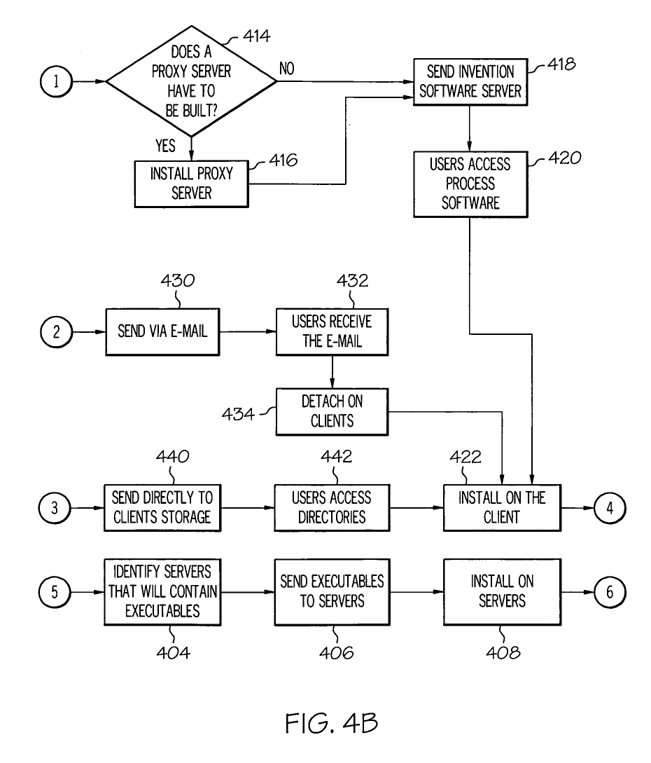

Referring then to FIG. 4, step 400 begins the deployment of the process software. The first thing is to determine if there are any programs that will reside on a server or servers when the process software is executed (query block 402). If this is the case, then the servers that will contain the executables are identified (block 404). The process software for the server or servers is transferred directly to the servers' storage via File Transfer Protocol (FTP) or some other protocol or by copying though the use of a shared file system (block 406). The process software is then installed on the servers (block 408).

Next, a determination is made on whether the process software is to be deployed by having users access the process software on a server or servers (query block 410). If the users are to access the process software on servers, then the server addresses that will store the process software are identified (block 412).

A determination is made if a proxy server is to be built (query block 414) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 416). The process software is sent to the servers either via a protocol such as FTP or it is copied directly from the source files to the server files via file sharing (block 418). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 420). Another embodiment is to have the servers automatically copy the process software to each client and then run the installation program for the process software at each client computer. The user executes the program that installs the process software on his client computer (block 422) then exits the process (terminator block 424).

In query step 426, a determination is made whether the process software is to be deployed by sending the process software to users via e-mail. The set of users where the process software will be deployed are identified together with the addresses of the user client computers (block 428). The process software is sent via e-mail to each of the users' client computers (block 430). The users then receive the e-mail (block 432) and then detach the process software from the e-mail to a directory on their client computers (block 434). The user executes the program that installs the process software on his client computer (block 422) then exits the process (terminator block 424).

Lastly a determination is made on whether to the process software will be sent directly to user directories on their client computers (query block 436). If so, the user directories are identified (block 438). The process software is transferred directly to the user's client computer directory (block 440). This can be done in several ways such as, but not limited to, sharing of the file system directories and then copying from the sender's file system to the recipient user's file system or alternatively using a transfer protocol such as File Transfer Protocol (FTP). The users access the directories on their client file systems in preparation for installing the process software (block 442). The user executes the program that installs the process software on his client computer (block 422) and then exits the process (terminator block 424).

VPN Deployment

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

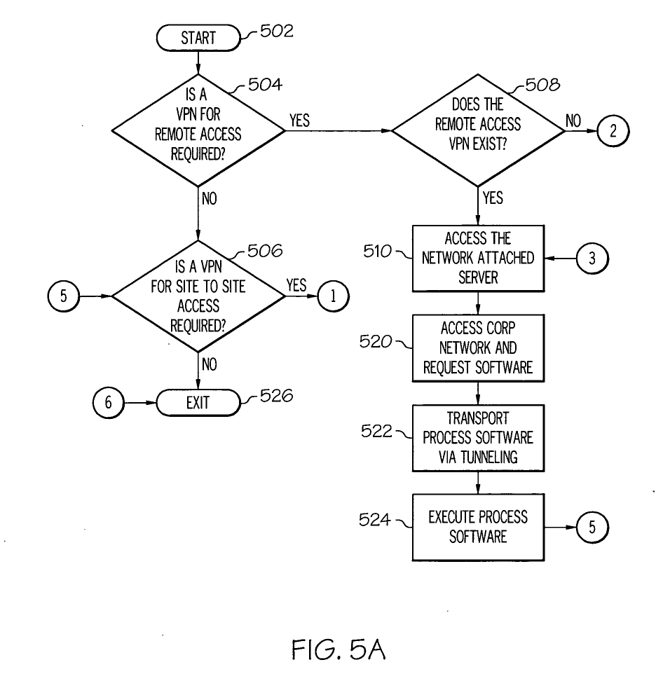

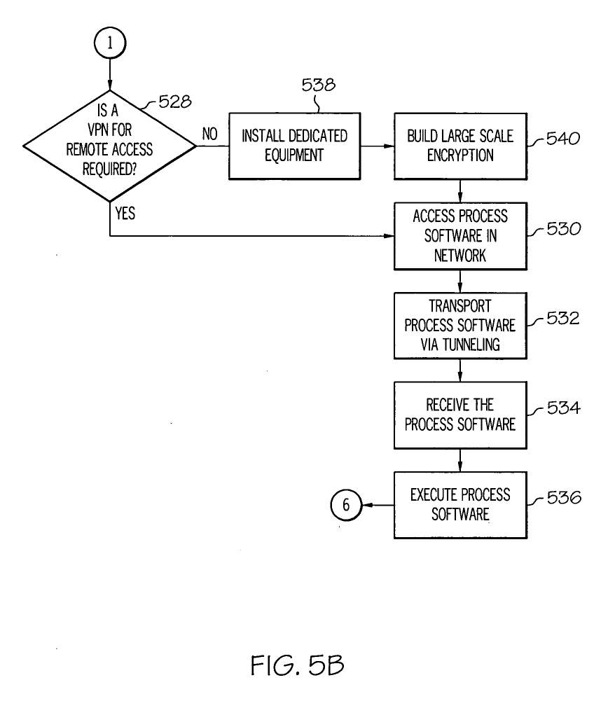

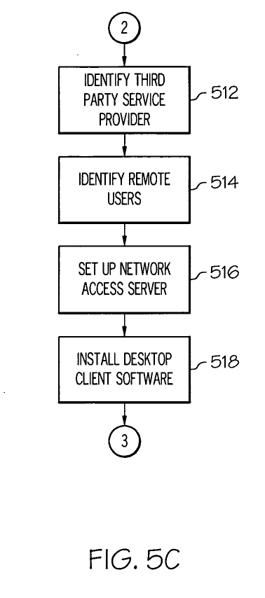

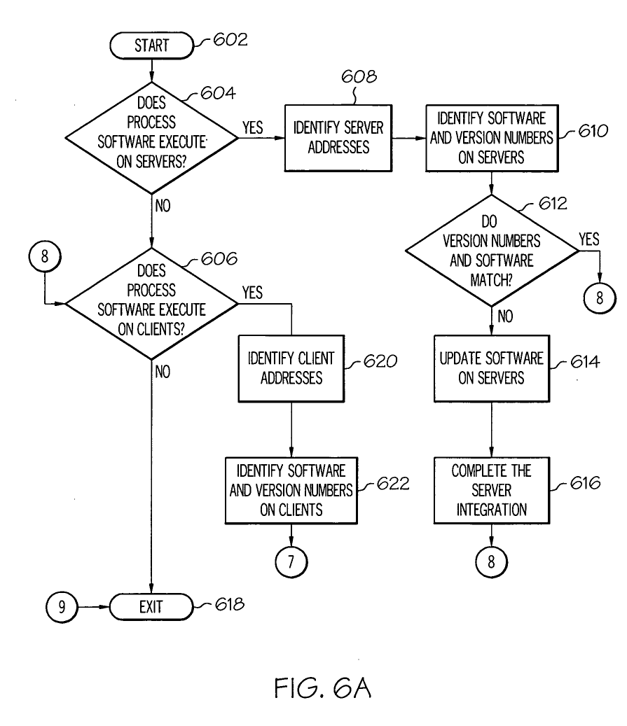

The process for such VPN deployment is described in FIG. 5. Initiator block 502 begins the Virtual Private Network (VPN) process. A determination is made to see if a VPN for remote access is required (query block 504). If it is not required, then proceed to query block 506. If it is required, then determine if the remote access VPN exists (query block 508).

If a VPN does exist, then proceed to block 510. Otherwise identify a third party provider that will provide the secure, encrypted connections between the company's private network and the company's remote users (block 512). The company's remote users are identified (block 514). The third party provider then sets up a network access server (NAS) (block 516) that allows the remote users to dial a toll free number or attach directly via a broadband modem to access, download and install the desktop client software for the remote-access VPN (block 518).

After the remote access VPN has been built or if it has been previously installed, the remote users can access the process software by dialing into the NAS or attaching directly via a cable or DSL modem into the NAS (block 510). This allows entry into the corporate network where the process software is accessed (block 520). The process software is transported to the remote user's desktop over the network via tunneling. That is, the process software is divided into packets and each packet including the data and protocol is placed within another packet (block 522). When the process software arrives at the remote user's desktop, it is removed from the packets, reconstituted and then is executed on the remote user's desktop (block 524).

A determination is then made to see if a VPN for site to site access is required (query block 506). If it is not required, then proceed to exit the process (terminator block 526). Otherwise, determine if the site to site VPN exists (query block 528). If it does exist, then proceed to block 530. Otherwise, install the dedicated equipment required to establish a site to site VPN (block 538). Then build the large scale encryption into the VPN (block 540).

After the site to site VPN has been built or if it had been previously established, the users access the process software via the VPN (block 530). The process software is transported to the site users over the network via tunneling (block 532). That is the process software is divided into packets and each packet including the data and protocol is placed within another packet (block 534). When the process software arrives at the remote user's desktop, it is removed from the packets, reconstituted and is executed on the site user's desktop (block 536). The process then ends at terminator block 526.

Software Integration

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

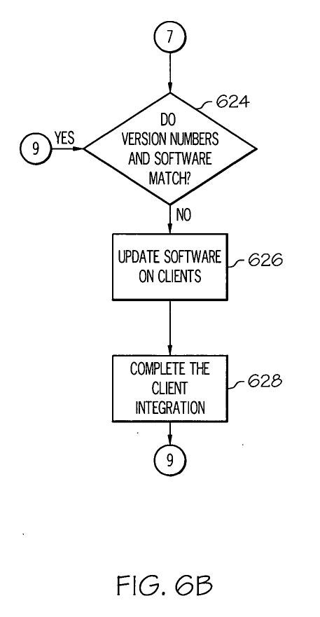

For a high-level description of this process, reference is now made to FIG. 6. Initiator block 602 begins the integration of the process software. The first tiling is to determine if there are any process software programs that will execute on a server or servers (block 604). If this is not the case, then integration proceeds to query block 606. If this is the case, then the server addresses are identified (block 608). The servers are checked to see if they contain software that includes the operating system (OS), applications, and network operating systems (NOS), together with their version numbers, which have been tested with the process software (block 610). The servers are also checked to determine if there is any missing software that is required by the process software in block 610.

A determination is made if the version numbers match the version numbers of OS, applications and NOS that have been tested with the process software (block 612). If all of the versions match and there is no missing required software the integration continues in query block 606.

If one or more of the version numbers do not match, then the unmatched versions are updated on the server or servers with the correct versions (block 614). Additionally, if there is missing required software, then it is updated on the server or servers in the step shown in block 614. The server integration is completed by installing the process software (block 616).

The step shown in query block 606, which follows either the steps shown in block 604, 612 or 616 determines if there are any programs of the process software that will execute on the clients. If no process software programs execute on the clients the integration proceeds to terminator block 618 and exits. If this not the case, then the client addresses are identified as shown in block 620.

The clients are checked to see if they contain software that includes the operating system (OS), applications, and network operating systems (NOS), together with their version numbers, which have been tested with the process software (block 622). The clients are also checked to determine if there is any missing software that is required by the process software in the step described by block 622.

A determination is made is the version numbers match the version numbers of OS, applications and NOS that have been tested with the process software (query block 624). If all of the versions match and there is no missing required software, then the integration proceeds to terminator block 618 and exits.

If one or more of the version numbers do not match, then the unmatched versions are updated on the clients with the correct versions (block 626). In addition, if there is missing required software then it is updated on the clients (also block 626). The client integration is completed by installing the process software on the clients (block 628). The integration proceeds to terminator block 618 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

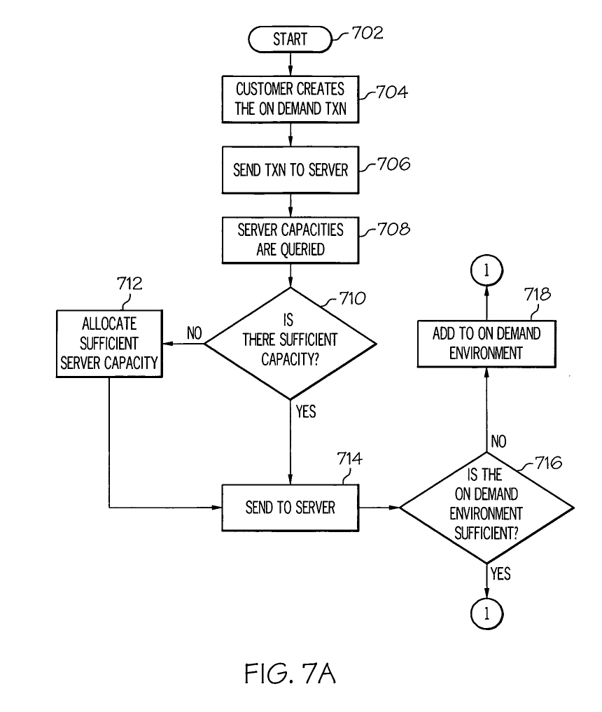

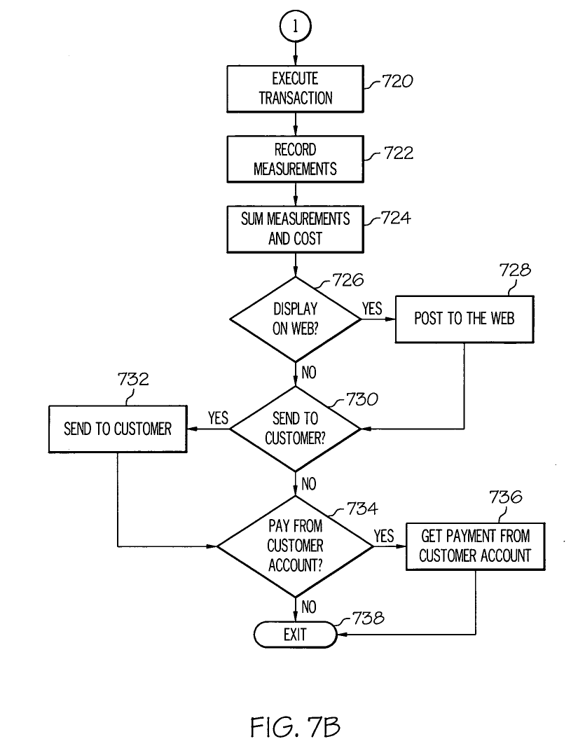

With reference now to FIG. 7, initiator block 702 begins the On Demand process. A transaction is created than contains the unique customer identification, the requested service type and any service parameters that further, specify the type of service (block 704). The transaction is then sent to the main server (block 706). In an On Demand environment the main server can initially be the only server, then as capacity is consumed other servers are added to the On Demand environment.

The server central processing unit (CPU) capacities in the On Demand environment are queried (block 708). The CPU requirement of the transaction is estimated, then the servers available CPU capacity in the On Demand environment are compared to the transaction CPU requirement to see if there is sufficient CPU available capacity in any server to process the transaction (query block 710). If there is not sufficient server CPU available capacity, then additional server CPU capacity is allocated to process the transaction (block 712). If there was already sufficient available CPU capacity then the transaction is sent to a selected server (block 714).

Before executing the transaction, a check is made of the remaining On Demand environment to determine if the environment has sufficient available capacity for processing the transaction. This environment capacity consists of such things as but not limited to network bandwidth, processor memory, storage etc. (block 716). If there is not sufficient available capacity, then capacity will be added to the On Demand environment (block 718). Next the required software to process the transaction is accessed, loaded into memory, then the transaction is executed (block 720).

The usage measurements are recorded (block 722). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 724).

If the customer has requested that the On Demand costs be posted to a web site (query block 726), then they are posted (block 728). If the customer has requested that the On Demand costs be sent via e-mail to a customer address (query block 730), then these costs are sent to the customer (block 732). If the customer has requested that the On Demand costs be paid directly from a customer account (query block 734), then payment is received directly from the customer account (block 736). The On Demand process is then exited at terminator block 738.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method comprising:
determining that at least one resource among a plurality of resources implemented in a data processing system has become unavailable;
identifying at least one dependent resource among said plurality of resources that is dependent on said at least one unavailable resource;
in response to said identifying said at least one dependent resource, disabling said at least one dependent resource;
detecting recovery of said at least one unavailable resource; and
in response to detecting recovery of said at least one unavailable resource, restarting said at least one dependent resource.

2. The computer-implementable method according to claim 1, further comprising:
redirecting a plurality of tasks to be performed by said at least one unavailable resource among said plurality of resources.

3. The computer-implementable method according to claim 1, wherein said determining further comprises:
monitoring said data processing system for an error message indicating that said at least one resource has become unavailable.

4. The computer-implementable method according to claim 1, further comprising:
in response to determining said at least one resource among a plurality of resources implemented in said data processing system has become unavailable, indicating if said at least one unavailable resource is at least one redundant resource among a plurality of redundant resources;
in response to indicating said at least one unavailable resource is at least one redundant resource, idling said at least one redundant resource; and
in response to said idling, forwarding at least one existing transaction to other redundant resources among said plurality of redundant resources for processing.

5. The computer-implementable method according to claim 1, further comprising:
in response to determining said at least one resource among a plurality of resources implemented in said data processing system has become unavailable, indicating if said at least one unavailable resource is a stand-alone resource;
in response to indicating said at least one unavailable resource is a stand-alone resource, idling said stand-alone resource; and
in response to said idling, ending at least one existing transaction on said stand-alone resource by returning an error message indicating an unavailable status of said stand-alone resource.

6. The computer-implementable method according to claim 1, further comprising:
in response to determining said at least one resource among a plurality of resources implemented in said data processing system has become unavailable, indicating if said at least one unavailable resource is an entire set of redundant resources;
in response to indicating said at least one unavailable resource is said entire set of redundant resources, idling said entire set of redundant resources; and
in response to said idling, ending at least one existing transaction on said entire set of redundant resources by returning an error message indicating an unavailable status of said entire set of redundant resources.

7. The system comprising:
a processor;
a data bus coupled to said processor; and
a computer-usable medium embodying computer code, said computer-usable medium being coupled to said data bus, said computer program code comprising instructions executable by said processor and configured for:
determining that at least one resource among a plurality of resources implemented in a data processing system has become unavailable;
identifying at least one dependent resource among said plurality of resources that is dependent on said at least one unavailable resource;
in response to said identifying said at least one dependent resource, disabling said at least one dependent resource;
detecting recovery of said at least one unavailable resource; and
in response to detecting recovery of said at least one unavailable resource, restarting said at least one dependent resource.

8. The system according to claim 7, wherein said instructions are further configured for:
redirecting a plurality of tasks to be performed by said at least one unavailable resource among said plurality of resources.

9. The system according to claim 7, wherein said instructions for determining are further configured for:
monitoring said data processing system for an error message indicating that said at least one resource has become unavailable.

10. The system according to claim 7, wherein said instructions are further configured for:
in response to determining said at least one resource among a plurality of resources implemented in said data processing system has become unavailable, indicating if said at least one unavailable resource is at least one redundant resource among a plurality of redundant resources;
in response to indicating said at least one unavailable resource is at least one redundant resource, idling said at least one redundant resource; and
in response to said idling, forwarding at least one existing transaction to other redundant resources among said plurality of redundant resources for processing.

11. The system according to claim 7, wherein said instructions are further configured for:
in response to determining said at least one resource among a plurality of resources implemented in said data processing system has become unavailable, indicating if said at least one unavailable resource is a stand-alone resource;
in response to indicating said at least one unavailable resource is a stand-alone resource, idling said stand-alone resource; and
in response to said idling, ending at least one existing transaction on said stand-alone resource by returning an error message indicating an unavailable status of said stand-alone resource.

12. The system according to claim 7, wherein said instructions are further configured for:
in response to determining said at least one resource among a plurality of resources implemented in said data processing system has become unavailable, indicating if said at least one unavailable resource is an entire set of redundant resources;
in response to indicating said at least one unavailable resource is said entire set of redundant resources, idling said entire set of redundant resources; and
in response to said idling, ending at least one existing transaction on said entire set of redundant resources by returning an error message indicating an unavailable status of said entire set of redundant resources.

13. A computer-usable medium embodying computer program code, said computer program code comprising computer executable instructions configured for:
determining that at least one resource among a plurality of resources implemented in a data processing system has become unavailable;
identifying at least one dependent resource among said plurality of resources that is dependent on said at least one unavailable resource;
in response to said identifying said at least one dependent resource, disabling said at least one dependent resource;
detecting recovery of said at least one unavailable resource; and
in response to detecting recovery of said at least one unavailable resource, restarting said at least one dependent resource.

14. The computer-usable medium according to claim 13, wherein said embodied computer program code further comprises computer executable instructions configured for:
redirecting a plurality of tasks to be performed by said at least one unavailable resource among said plurality of resources.

15. The computer-usable medium according to claim 13, wherein said computer executable instructions for determining are further configured for:
monitoring said data processing system for an error message indicating that said at least one resource has become unavailable.

16. The computer-usable medium according to claim 13, wherein said embodied computer program code further comprises computer executable instructions configured for:
in response to determining said at least one resource among a plurality of resources implemented in said data processing system has become unavailable, indicating if said at least one unavailable resource is at least one redundant resource among a plurality of redundant resources;
in response to indicating said at least one unavailable resource is at least one redundant resource, idling said at least one redundant resource; and
in response to said idling, forwarding at least one existing transaction to other redundant resources among said plurality of redundant resources for processing.

17. The computer-usable medium according to claim 13, wherein said embodied computer program code further comprises computer executable instructions configured for:
in response to determining said at least one resource among a plurality of resources implemented in said data processing system has become unavailable, indicating if said at least one unavailable resource is a stand-alone resource;
in response to indicating said at least one unavailable resource is a stand-alone resource, idling said stand-alone resource; and
in response to said idling, ending at least one existing transaction on said stand-alone resource by returning an error message indicating an unavailable status of said stand-alone resource.

18. The computer-usable medium according to claim 13, wherein said embodied computer program code further comprises computer executable instructions configured for:
in response to determining said at least one resource among a plurality of resources implemented in said data processing system has become unavailable, indicating if said at least one unavailable resource is an entire set of redundant resources;
in response to indicating said at least one unavailable resource is said entire set of redundant resources, idling said entire set of redundant resources; and
in response to said idling, ending at least one existing transaction on said entire set of redundant resources by returning an error message indicating an unavailable status of said entire set of redundant resources.

19. The computer-usable medium according to claim 13, wherein said computer executable instructions are deployable to a client computer from a server at a remote location.

20. The computer-usable medium according to claim 13, wherein said computer executable instructions are provided by a service provider to a customer on an on-demand basis.
